(19) United States
(12) Patent Application Publication
(10) Pub. No.: US 2004/0061008 A1
(43) Pub. Date: Apr. 1, 2004

(54) Berley macerator

(76) Inventors: Alexander D. Hauler, Dandenong (AU); Martin Robson, Tyabb (AU); Eric P. Willmot, Mount Eliza (AU); David Ellis, Carrum Downs (AU)

Correspondence Address: RYAN KROMHOLZ & MANION, S.C., POST OFFICE BOX 26618, MILWAUKEE, WI, 53226, US

(21) Appl. No.: 10/250,403

(22) PCT Filed: Dec. 7, 2001
(86) PCT No.: PCT/AU01/01581

(30) Foreign Application Priority Data
Jan. 17, 2001 (AU) PR 2574
Sep. 6, 2001 (AU) PR 7537

(51) Int. Cl. B02C 19/12

(52) U.S. Cl. 241/101.2; 241/199.12

(57) ABSTRACT

A berley macerator (10) has a bucket (14) for receiving material to be macerated. A motor (20) is provided for driving a worm which in turn drives a worm wheel (22). A chopper blade (36), mounted on the worm wheel (22), rotates with the worm wheel (22) to macerate the material. A motor control circuit is provided for driving the motor (20) and also for determining if the blade (36) becomes jammed so that the motor (20) can be switched off and an audible signal provided to indicate that a jam has occurred.

This invention relates to a berley macerator for chopping and distributing organic fish products which will be used as fish bait.

Berley is conventionally used by fisherpersons to attract fish. The berley normally comprises any organic matter from which fish will normally feed including fish scraps, fish bait and other fish attracting foods. Typically such organic matter is added to a berley bucket and a handled plunger is used to manually macerate the organic matter. The macerated particles are washed out of the berley bucket by the wave action of the surrounding water with the intent of producing a continuous berley trail in the water. The presence of the berley in the water attracts fish in the vicinity of the boat thereby increasing the probability of a catch.

The traditional process is manual and labour intensive, and requiring the fisherpersons to repeatedly stop fishing and manually macerate the berley. This process has the disadvantage of requiring repetitive interruption of actual fishing and the intermittent berleying does not provide a continuous berley trail.

The invention, in a first aspect, may be said to reside in a berley macerator including;

a container having a peripheral wall;

at least one hole in the peripheral wall for enabling berley within the container to pass out of the container through the hole;

a chopper arranged within the container;

a drive means for rotating the chopper about an axis, the driv means having;

a worm wheel having peripheral gear teeth, the worm wheel being coupled to th chopper;

a worm gear engaging the peripheral teeth of the worm wheel; and

a motor for driving the worm gear, the motor having a drive shaft coupled to the worm gear and the motor and drive shaft being arranged so the motor and shaft extend transverse to the axis about which the chopper rotates, so that when the motor drives the worm gear the worm gear rotates the worm wheel to in turn drive the chopper so that material deposited in the container can be chopped or cut to form berley.

The arrangement of the worm wheel and worm gear enables the overall height of the macerator to be maintained to a minimum because the motor and the drive shaft from the motor can be effectively arranged perpendicular to the axis about which the chopper rotates. This decreases the height of the macerator and thereby does not significantly increase the overall draft of the berley macerator when the macerator is located on a boat. This is particularly important because if the draft is increased, there is obviously an overall loss of efficiency, and also the pressure exerted on the drive assembly, particularly if the drive assembly is attached to a bucket in the form of a plastic container, may be sufficient to tear the drive assembly from the bucket. Furtherstill, if the drive assembly does greatly increase the overall draft, it may cause turbulence and spray to be created at the rear of the boat which may find its way into an outboard motor and damage the outboard motor.

In one embodiment of the invention the worm wheel and worm gear are arranged within the container.

However, in an alternative embodiment the container has a bas and the worm wheel and worm gear are arranged outside the container beneath the base, the chopper being connected to the worm wheel by a shaft which passes through the base.

Preferably the worm wheel includes a plurality of flutes and an end most flute in the direction of drive has at least one cut or notch so that any material which accumulates in the flutes can be driven out of the worm gear through the cut or notch by the action and engagement of the worm gear and the worm wheel.

In the embodiment in which the worm wheel is located within the container, the worm wheel may include paddles for forcing water towards the openings in the peripheral wall thereby facilitating the flow of berley out through the openings.

Preferably a motor control circuit is included which has means for sensing when the chopper is prevented from rotating and for shutting off power to the motor.

This embodiment allows the motor to be shut off should the chopper become blocked by, for example, a build up of material in the macerator which prevents rotation of the chopper, notwithstanding the fact that power is supplied to the motor, so that the motor can be stopped to enable the blockage to be cleared.

The sensing means may comprise a current sensing means for sensing current drawn by the motor so that when the current exceeds a predetermined level, power to the motor is shut off. The current sensing means may be designed such that it shuts off power supply to the motor upon stopping of the chopper or, alternatively, only if the motor tends to draw a current beyond a predetermined limit, notwithstanding the fact that the chopper has been stopped.

In anoth r embodiment, the sensing means may be a sensor for sensing the speed of rotation of the motor and therefore the chopper so that if the chopper and motor stop rotating, power supply to the motor is switched off.

In a further aspect the invention may be said to reside in a drive assembly for a berley macerator, the drive assembly including;

a worm wheel having peripheral teeth;

a worm gear engaged with the peripheral teeth;

a motor for driving the worm gear;

a shaft coupled to the worm wheel for rotation with the worm wheel;

a chopper blade for coupling with the shaft; and

wherein the motor is operable to drive the worm gear to, in turn, drive the worm wheel to rotate the shaft and the chopper blade about a rotation axis, the motor and worm gear being arranged tranverse to the rotation axis.

This aspect of the invention has particular application to providing a drive and chopper assembly to an existing berley bucket. The assembly can be located beneath the bucket and fixed in place by bolts or like fasteners with the shaft passing through a base of the bucket so that the chopper can be located on the shaft and inside the bucket.

Preferably the assembly is located within a casing which has a first casing portion and a second casing portion defining a cavity, the motor, the worm wheel and the worm gear being located in the cavity;

the first casing portion having an upwardly extending sleeve through which the shaft extends and the chopper being fixable to the shaft after location of the shaft through the base of a container so as to thereby locate the chopper within the berley macerator and provide drive from the worm wheel to the chopp r to chop or cut mat rial deposited into the macerator into berley.

Preferably a motor control circuit is included which has means for sensing when the chopper is prevented from rotating and for shutting off power to the motor.

This embodiment allows the motor to be shut off should the chopper become blocked by, for example, a build up of material in the macerator which prevents rotation of the chopper, notwithstanding the fact that power is supplied to the motor, so that the motor can be stopped to enable the blockage to be cleared.

The sensing means may comprise a current sensing means for sensing current drawn by the motor so that when the current exceeds a predetermined level, power to the motor is shut off. The current sensing means may be designed such that it shuts off power supply to the motor upon stopping of the chopper or, alternatively, only if the motor tends to draw a current beyond a predetermined limit, notwithstanding the fact that the chopper has been stopped.

In another embodiment, the sensing means may be a sensor for sensing the speed of rotation of the motor and therefore the chopper so that if the chopper and motor stop rotating, power supply to the motor is switched off.

A further aspect of the invention may be said to reside in a drive assembly for a berley macerator, the drive assembly including:

a chopper blade;

a motor for driving the chopper blade so as to rotate the chopper blade to enable material to be macerated; and

control means for controlling operation of the motor, the control means including:

sensing means for s nsing if the motor stops whilst power is supplied to the motor; and

switch means for switching off power supplied to the motor upon sensing of the stopping of the motor.

In one embodiment of the invention, the sensing means comprises a current sensing means for sensing current drawn by the motor so that if the current exceeds a predetermined value, the current sensing device shuts off power to the motor.

Preferably an audible alarm is provided such that in the even of the chopper being stopped from rotating, a signal is generated to sound the audible alarm.

In a further embodiment, the sensing means may comprise a sensor for sensing rotation of the chopper so that if the chopper stops rotating, the sensor provides a signal to cause power supplied to the motor to be shut off.

Preferably the control circuitry comprises pulse width modulated power supply means for supplying a pulse width modulated signal to the motor to control the speed of the motor in accordance with the duty cycle of the pulse width modulated signal.

Preferred embodiments of the invention will be described, by way of example, with reference to the accompanying drawings in which;

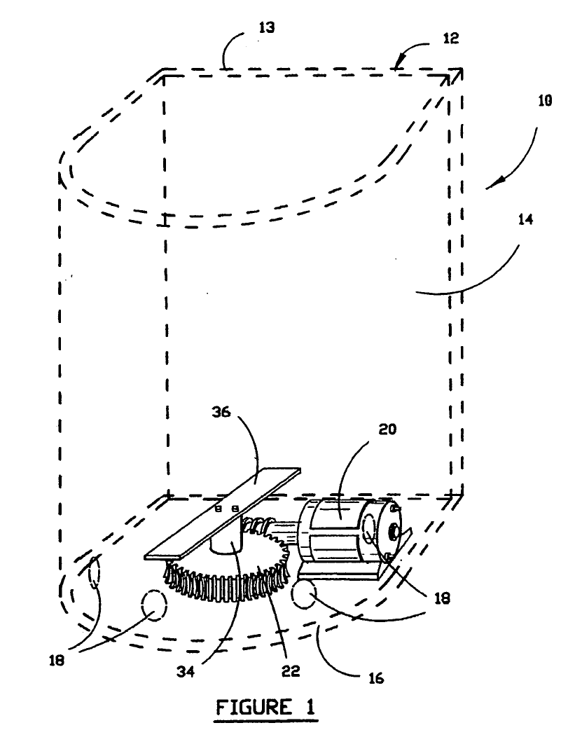

FIG. 1 is a view of the berley macerator according to first embodiment of the invention;

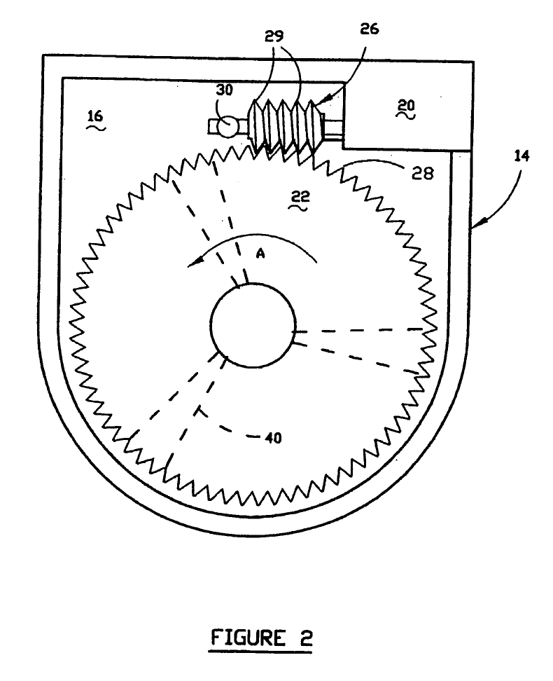

FIG. 2 is a plan view of the macerator of FIG. 1;

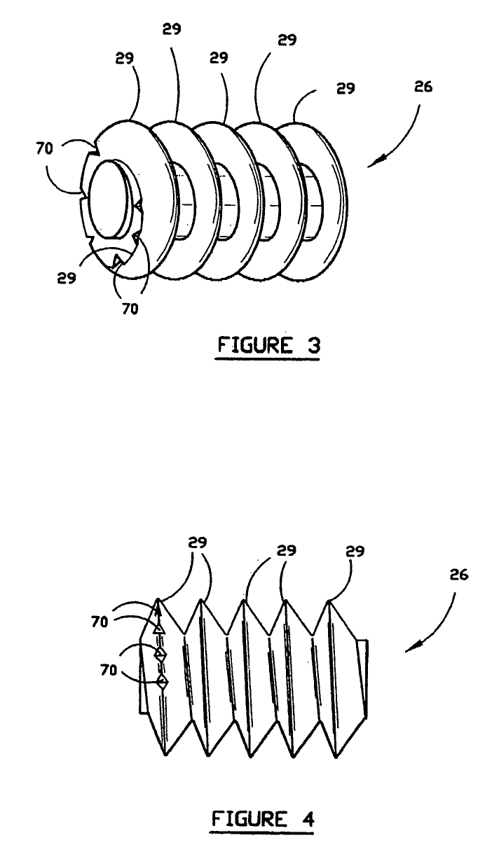

FIG. 3 is a perspective view of a worm gear in used in the embodiment of FIG. 1;

FIG. 4 is a side view of the worm gear of FIG. 1;

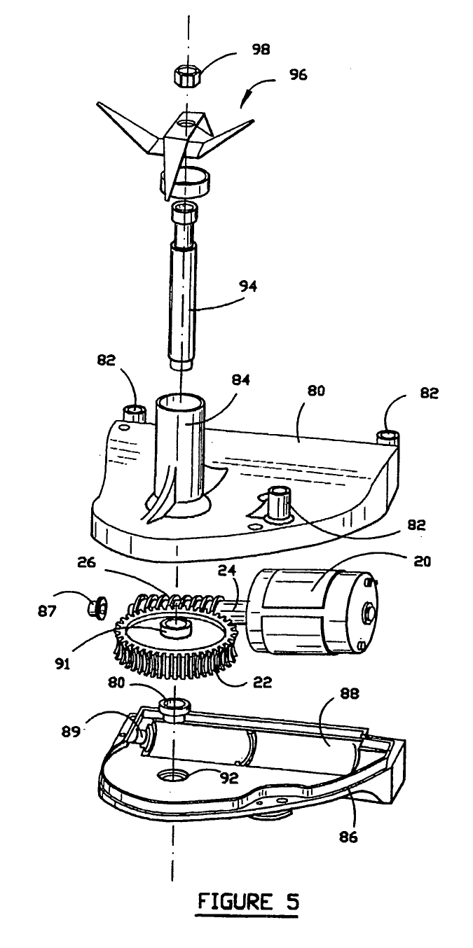

FIG. 5 is an exploded vi w of a further embodim nt of the invention;

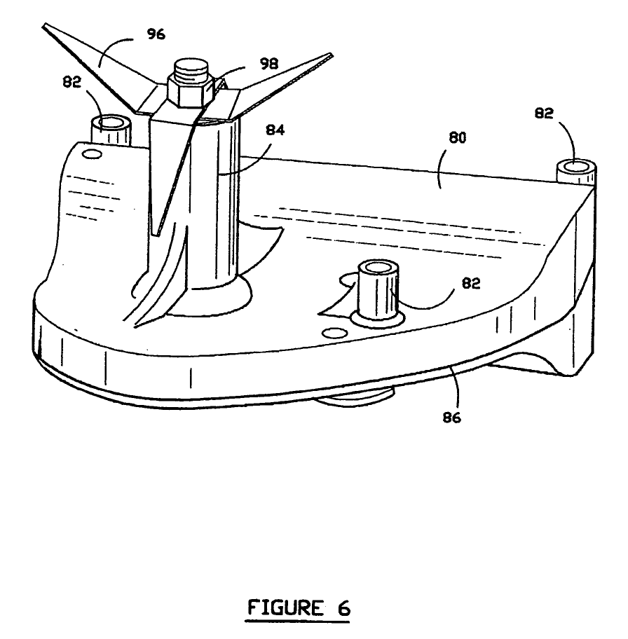

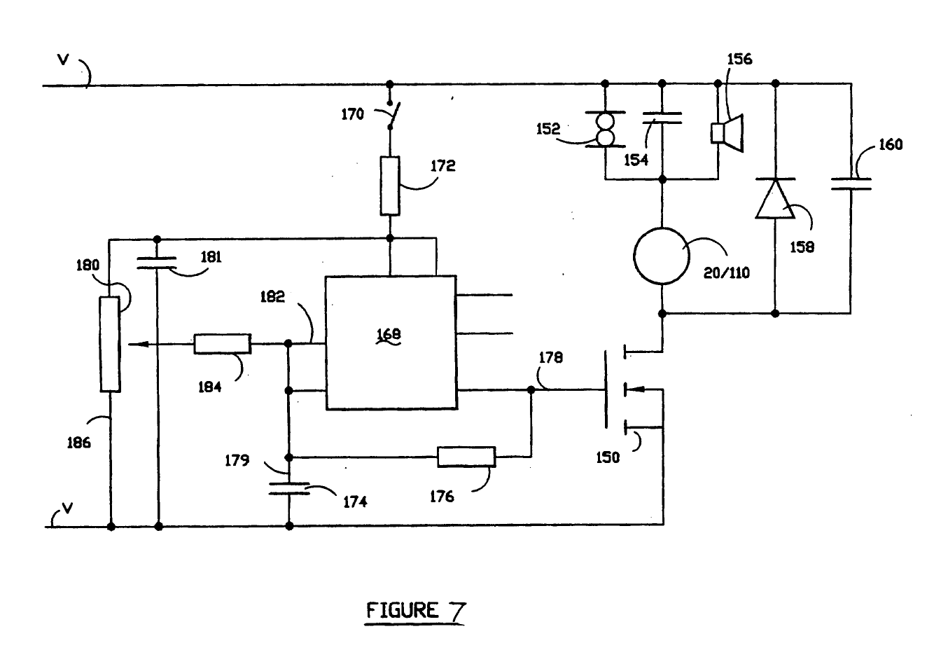

FIG. 6 is an assembled view of the embodiment of FIG. 5;

FIG. 7 is a circuit diagram of a control circuit according to one embodiment of the invention; and

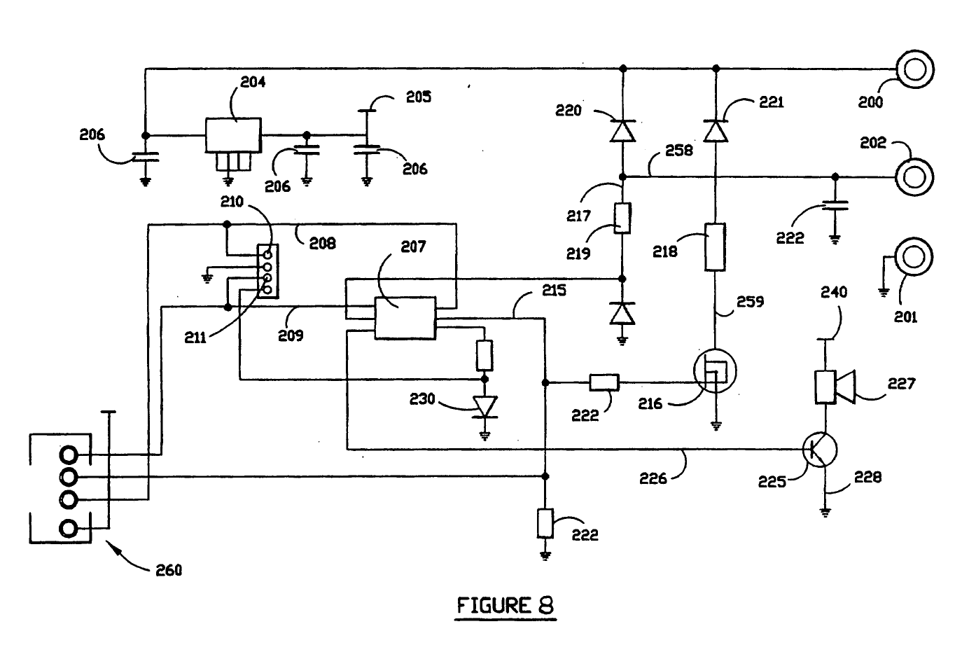

FIG. 8 is a circuit diagram of a second circuit arrangement used in the preferred embodiment of the invention.

A berley macerator 10 according to a first embodiment of the invention is shown in FIG. 1. The macerator 10 comprises a container 12 which has a peripheral wall 14. In the embodiments shown the general cross-sectional shape of the container 12 is “D” shaped. However, the container could be of circular cross-section or of any other configuration. The peripheral wall 14 in this embodiment of the invention includes a generally flat base 16. The peripheral wall 14 includes a plurality of outlet holes 18 (some of which are formed in the base 16) for enabling berley which is chopped in the container 12, in the manner to be described hereinafter, to flow out through the holes 18 into the surrounding water to attract fish.

The macerator 10 has a motor 20 which is arranged within the container 12. A worm wheel 22 is journalled in the container 12 on the base 16.

As is best shown in FIG. 2 the motor 20 has an output shaft 24 which carries a worm gear 26. The worm wheel 22 has teeth 28 on its periphery and the teeth 28 engage the flutes 29 of the worm wheel 26. The shaft 24, as is seen in FIG. 2, passes through the worm wheel 26 and is journalled in a journal block 30 fixed to the base 16.

The worm wheel 22 supports a shaft 34 which may be fixed to the worm wheel 22 by any suitable means or made integral with the worm wheel 22. A chopper 36 is located on the shaft 34 for chopping material deposited into the container 12.

When the motor 20 is activated the shaft 24 is rotated to in turn rotate the worm gear 26. Rotation of the worm gear drives the worm wheel 22 in the direction of arrow A in FIG. 2, (for example) by virtue of the engagement of the flutes 29 of the worm gear 26 with the teeth 28 of the worm wheel 22. This in turn rotates the shaft 34 which rotates the chopper 36 so that material deposited in the container 12 is cut or chopped into pieces so that those pieces can flow out through the holes 18 as previously described.

In the embodiments shown in FIGS. 1 and 2 the worm wheel 22, worm gear 26 and motor 20 are located within the container 12. In other embodiments these components could be contained outside of the container 12 by, for example, being located below the base 16. In this embodiment the shaft 34 would project up through the base 16 so that the chopper 36 would be located within the container 12 for chopping material deposited in the container 12.

In the embodiment in which the components are located within the container 12, the worm wheel 22 may carry paddles 40 (shown in FIG. 2) on its upper or lower surface to make the water flow towards the holes 18 for facilitating transport of the berley out of the container 12 through the holes 18 to the surrounding water.

This tends to facilitate the natural flow of the material out of the container 12 which is caused by wave action of the surrounding water, in which the berley macerator is partially submerged, which tends to create a flow through holes 18 and, in some instances, over the upper rim 13 of the container 12.

In the embodiment in which the worm wheel 22 and worm gear 29 are locat d within the container 12 the flutes 29 of the worm gear 26, as is shown in FIG. 3, are provided with cut outs or notches 70. As shown in FIG. 3, the notches 70 are provided in an end most one of the flutes 29 having regard to the direction of drive supplied by the wheel 26 so that any material which accumulates within the flutes 29 is transported along the flutes 29 by virtue of the engagement of the flutes 29 with the teeth 28 and can pass out through the notches 70 so as to not jam the worm wheel 22 and the worm gear 26. If desired similar cut outs or notches can be provided in other of the flutes 29 to facilitate removal of material which may tend to accumulate in the worm flutes 29 or, for that matter, within the teeth 28 of the worm wheel 22.

The water in which the berley macerator is located provides a lubricant for lubricating the worm wheel 22 and the worm gear 26. In the embodiment in which the worm wheel 22 and worm gear 26 are located within the container 14, any fish oil or like oily substance which is created upon chopping of the material deposits into the container 14, also acts as a lubricant to lubricate the worm wheel 28 and the worm gear 26. The worm wheel 28 and worm gear 26 may be formed from metal or plastics material.

FIG. 5 shows a further embodiment of the invention which is intended to act as an add on to an existing berley bucket. In this embodiment the drive assembly will be located outside of the berley bucket generally beneath a base of the berley bucket.

The assembly shown in FIG. 5 has an upper casing portion 80 which has sleeves 82 for receiving bolts (not shown) for securing the m chanism to an existing berley bucket. The casing part 80 also has a sleeve 84. A lower casing part 86 is provided with a part cylindrical section 88 which is intended to receive motor 20. Output shaft 24 carries worm gear 26 as in the earlier embodiment and, in this embodiment an end bearing 87 is provided for journalling the end of the shaft 24. The bearing 87 seats in a shaped recess 89 provided in the casing 88. Worm wheel 22 which engages the worm gear 26 is rotatably supported on bearing 90 which can seat in a recess 92 formed in the casing 88. In this embodiment drive shaft 94 passes through the sleeve 88 and central hub 91 of the worm wheel 22 to engage in bearing 80. The worm wheel 22 is fixed onto the shaft 94 by any suitable method so that when the wheel 22 rotated the shaft 94 will also rotate.

When the casing parts 80 and 86 are coupled together the motor 20, worm gear 26 and worm wheel 22 are sealed within the casing formed from the two parts 80 and 86. A seal may be provided in the sleeve 84 about the shaft 94 for preventing water ingress into the casing if desired. Leeds for powering the motor 22 can extend out of the casing through a sealed aperture (not shown) for supplying electric power to the motor 20. A lubricant may be included in the casing to lubricate the wheel 22 and gear 26.

In order to attach the drive assembly shown in FIG. 5 to an existing bucket of a berley macerator, a hole is formed in the base so that the sleeve 84 can project through the base of the bucket. The casing formed by the parts 80 and 86 is secured to the underside of the base of the bucket, and after location of the sleeve 84 and the therefore the shaft 94 through the hole in the bottom of the bucket, chopper blade 96 can be fixed onto the shaft 94 by a nut 98.

Thus, the embodiment of FIGS. 5 and 6 provides a ready attachment to an existing berley bucket which operates in the same fashion as in the embodiment of FIGS. 1 to 2 expect that the container 12 need not be provided.

FIG. 7 shows a circuit diagram of a controller for controlling operation of the motor 20 described with reference to FIGS. 1 to 6. With reference to FIG. 7, the motor 20 is located across a voltage source V/Vo of for example 12 volts. The motor 20 is in series with a field effect transistor 150. The motor is also in series with a circuit comprising a current limitor 152, capacitor 154 and a speaker 156. During normal operation, when the field effect transistor 150 is switched on, as will be described hereinafter, current flows through the current limiting device 152 to the motor 20 with virtually no voltage drop across the current limiting device 152 so that motor 20 is supplied with power and accordingly operates. Diode 158 prevents supply of current to the motor in the reverse direction and capacitor 160 and capacitor 154 smooth the current supplied to the motor 20.

A counter chip (cmos counter chip 7555) 168 is also connected across the voltage source V and VO via a switch 170, resistor 172 and capacitors 174 and 181. A stabilising resistor 176 is also connected between output 178 from the chip 168 and line 179. A potentiometer 180 is connected to an input 182 to the chip 168 via resistor 184. The potentiometer is connected in parallel with the power supply V and VO as shown via line 186, resistor 172 and the switch 170. When the switch 170 is closed the chip 168 is powered and a pulse width modulated signal is output on line 178 to the transistor 150. The duty cycle of the pulse width modulated signal is set by the potentiometer 180 and by changing the value of the resistance of the potentiometer (that is the division ratio of the voltage of the potentiometer) which is suppli d on line 182, the duty cycle of the pulse width modulated signal on line 178 can be altered. The alteration of the duty cycle may not be linearly proportional to the voltage division of the potentiometer 180 and there also may be a change in frequency of the pulse width signal upon alteration of the adjustment of the potentiometer 180. However, the pulse width modulated signal will cause the transistor 150 to switch on and off which in turn will enable current to be supplied through the motor 20 to voltage source VO when the transistor is switched on to operate the motor. The speed of the motor will depend on the duty cycle of the pulse width modulated signal on line 178 and the time the transistor 150 is switched on and therefore by manipulating the potentiometer 180 the speed of the motor 20 can be controlled to a desired speed to provide required speed of rotation of the chopper to properly chop and macerate material supplied to the container 12 of the macerator described in the earlier embodiments.

If for some reason the chopper blade should jam because of becoming blocked or a build up of material in the container 12, any attempt by the motor 20 to draw additional current will be prevented by the current limiting device 152 and this will create a voltage drop across the current limiting device 152. This voltage drop will power the speaker 156 so that an audible alarm of a fault condition is provided. This enables the chopper to be cleared so that as soon as the device 152 cools, current can again be supplied to the motor 20 to operate the motor. Alternatively, the switch 170 can be opened so as to shut down the chip 168 to in turn, turn off the transistor 150 whilst the blockage in the container 12 is cleared.

FIG. 8 shows a second and preferred embodiment of the control circuitry used to operate the macerator according to the embodim nts of FIGS. 1 to 6.

The control circuity of FIG. 8 is connected to a battery at terminals 200 and 201. Motor 20 described with ref rence to the earlier embodiments is connected across terminal 200 and terminal 202.

Power supply from the terminal 200 is supplied to a regulator 204, which converts the, for example, 12 volt supply from the battery to a 5 volt signal at output 205. Capacitors 206 are provided to smooth the 5 volt signal provided at the output 205. Processor 207 has lines 208 and 209 connected to operator controllable switches 210 and 211, which are mounted on a face of the macerator for operator control. The switches 210 and 211 selectively enable the speed of the motor to be decreased or increased or to be manually shut off. Depression of one of the switches, such as the switch 210, will cause an increase in speed of the motor, depression of the switch 211 will cause a decrease in speed and simultaneously pressing both switches 210 and 211 will shut off the motor.

Processor 207 is connected to a field effect transistor 216 by line 215 and resistor 222 and supplies a pulse width modulated signal to the transistor 216. The duty cycle of the signal can be changed by depressing one of the switches 210 or 211. The pulse width signal periodically switches the transistor 216 on and off so that the greater the duty cycle, the longer the transistor 216 is switched on in each cycle and therefore, the faster the motor is driven. When the transistor is switched on, power flows through the motor via lines 258 and 259 and the transistor 216 to ground, thus driving the motor. A polyfuse 218 is connected in line 259 so that if the motor drives more current to a predetermined amount, the polyfuse 218 opens to stop flow of current through to the motor. Terminal 202 is also connected to the processor 207 via line 217 and resistor 219. Diodes 220 and 221 are provided between the terminals 200 and 202 and a capacitor 222 is provided for smoothing the voltage supply to the motor. The diodes 220 and 221 act as recirculating diodes to recirculate energy to the motor when current flors through the transistor 216.

The processor 207 is also connected to a transistor 225 by line 226. The transistor 225 is connected to a buzzer 227 which is supplied with the 5 volt power supply from the output 205. The emitter of the transistor 225 is connected to earth by line 228. A light emitting diode 230 is also connected to the processor 207 merely to indicate that the circuitry is in operation and to indicate the control circuitry shown in FIG. 8 has power supplied to it. The lines 208 and 209 read the switches 210 and 211 and the pulse with modulated output on line 215 is controlled by the processor 207 in accordance with the pressing of those switches. As previously mentioned, to increase speed of the motor, the switch 210 can be pressed and to decrease speed, the switch 211 can be depressed. This will change the duty cycle of the pulse with modulated signal in accordance with the programming of the processor 207 so as to change the duty cycle of the signal supplied on line 215 to thereby adjust the speed of the motor.

If the chopper blade of the motor stops, the motor will attempt to draw more current and the current drawn by the motor will be sensed by the resetable polyfuse 218. If the current exceeds a predetermined limit, the fuse will effectively open to thereby shut off the supply of current through the motor to stop the motor. When the increase in current occurs due to stopping of the chopper blade, such as for example by a build up of material or other blockage in the macerator, the increase in current is detected by the processor via line 218, which includes the resistor 219 to cause the processor 207 to output a signal on lin 226 to switch on transistor 225 so th transistor conducts. This allows current to be supplied from the voltage source 240 which is connect d to the output 205 and therefore supplied through the buzzer 227 to sound the buzzer. Thus, an alarm is generated to indicate that the chopper blade is no longer rotating and has been blocked so that the device can be cleared. If the current has exceeded the predetermined limit set by the polyfuse 218, power supply will be shut off to the motor by the processor switching off supply of the signal on line 215 and power supply will not recommence until the motor is switched off and the polyfuse 218 cools.

If the motor was operating at very low speed, it may be that the polyfuse has not triggered, notwithstanding the sense of increased current on line 218 which has generated the alarm because the chopper has stopped. In this case, the apparatus should be switched off by depressing both of the buttons 210 and 211 to enable the blockage to be cleared so that as soon as the blockage is cleared, the chopper blade does not continue to rotate, which may cause injury if clearance is performed by a user's hand. The likelihood of the polyfuse not triggering in the event of stopping of the chopper blade can be reduced or even eliminated by selecting a polyfuse which will react at a relatively low increase in current drawn by the motor which may occur when the chopper stops when the motor is operating at very low speed.

In another embodiment (not shown) sensing means for sensing the speed of rotation of the motor and the chopper may be included. The sensor will be connected to the processor 207 so that if the chopper blade stops, the sensor indicates this and supplies a signal to the processor 207 which shuts off the signal on line 215 to stop power supply to the motor. The processor may be programmed so that the blade will not b re-powered by the motor and processor 207 until aft r the switches 210 and 211 are switched off and then again switch d on to ensure that the motor does not op rate as soon as th blockage has been cleared to prevent a likelihood of injury to a user's hands should the user attempt to clear the blockage by hand.

The circuit of FIG. 8 may also include a programming link 260 for programming the processor 207 after installation in the circuit of FIG. 8.

Since modifications within the spirit and scope of the invention may readily be effected by persons skilled within the art, it is to be understood that this invention is not limited to the particular embodiment described by way of example hereinabove.

1. A berley macerator including;
a container having a peripheral wall;
at least one hole in the peripheral wall for enabling berley within the container to pass out of the container through the hole;
a chopper arranged within the container;
a drive means for rotating the chopper about an axis, the drive means having;
a worm wheel having peripheral gear teeth, the worm wheel being coupled to the chopper;
a worm gear engaging the peripheral teeth of the worm wheel; and
a motor for driving the worm gear, the motor having a drive shaft coupled to the worm gear and the motor and drive shaft being arranged so the motor and shaft extend transverse to the axis about which the chopper rotates, so that when the motor drives the worm gear the worm gear rotates the worm wheel to in turn drive the chopper so that material deposited in the container can be chopped or cut to form berley.

2. The berley macerator of claim 1 wherein the worm wheel and worm gear are arranged within the container.

3. The berley macerator of claim 1 wherein the container has a base and the worm wheel and worm gear are arranged outside the container beneath the base, the chopper being connected to the worm wheel by a shaft which passes through the base.

4. The berley macerator of claim 1 wherein the worm gear includes a plurality of flutes and an end most flute in the direction of drive has at least one cut or notch so that any material which accumulates in the flutes can be driven out of the worm gear through the cut or notch by the action and engagement of the worm gear and the worm wheel.

5. The berley macerator of claim 1 wherein the worm wheel is located within the container, the worm including paddles for forcing water towards the holes in the peripheral wall thereby facilitating the flow of berley out through the openings.

6. The berley macerator of claim 1 wherein a motor control circuit is included which has means for sensing when the chopper is prevented from rotating and for shutting off power to the motor.

7. The berley macerator of claim 6 wherein the sensing means comprises a current sensing means for sensing current drawn by the motor so that when the current exceeds a predetermined level, power to the motor is shut off.

8. The berley macerator of claim 6 wherein the sensing means is a sensor for sensing the speed of rotation of the motor and therefore the chopper so that if the chopper and motor stop rotating, power supply to the motor is switched off.

9. A drive assembly for a berley macerator, the drive assembly including;
a worm wheel having peripheral teeth;
a worm gear engaged with the peripheral teeth;
a motor for driving the worm gear;
a shaft coupled to the worm wheel for rotation with the worm wheel;
a chopper blade for coupling with the shaft; and
wherein the motor is operable to drive the worm gear to, in turn, drive the worm wheel to rotate the shaft and th chopper blade about a rotation axis, the motor and worm gear being arranged tranverse to the rotation axis.

10. The assembly of claim 9 wherein the assembly is located within a casing which has a first casing portion and a second casing portion which define a cavity therebetween, the motor, the worm wheel and the worm gear being located in the cavity;
the first casing portion having an upwardly extending sleeve through which the shaft extends and the chopper blade being fixable to the shaft after location of the shaft through the base of a container so as to thereby locate the chopper blade within the berley macerator and provide drive from the worm wheel to the chopper blade to chop or cut material deposited into the macerator into berley.

11. The assembly of claim 9 wherein a motor control circuit is included which has means for sensing when the chopper is prevented from rotating and for shutting off power to the motor.

12. The assembly of claim 11 wherein the sensing means comprises a current sensing means for sensing current drawn by the motor so that when the current exceeds a predetermined level, power to the motor is shut off.

13. The assembly of claim 11 wherein the sensing means is a sensor for sensing the speed of rotation of the motor and therefore the chopper so that if the chopper and motor stop rotating, power supply to the motor is switched off.

14. A drive assembly for a berley macerator, the drive assembly including:
a chopper blade;
a motor for driving the chopper blade so as to rotat the chopper blade to enable material to be macerated; and
control means for controlling operation of the motor, the control means including:
sensing means for sensing if the motor stops whilst power is supplied to the motor; and
switch means for switching off power supplied to the motor upon sensing of the stopping of the motor.

15. The drive assembly of claim 14 wherein the sensing means comprises a current sensing means for sensing current drawn by the motor so that if the current exceeds a predetermined value, the current sensing device shuts off power to the motor.

16. The drive assembly of claim 15 wherein an audible alarm is provided such that in the even of the chopper being stopped from rotating, a signal is generated to sound the audible alarm.

17. The drive assembly of claim 14 wherein the sensing means comprises a sensor for sensing rotation of the chopper so that if the chopper stops rotating, the sensor provides a signal to cause power supplied to the motor to be shut off.

18. The drive assembly of claim 14 wherein the control means comprises pulse width modulated power supply means for supplying a pulse width modulated signal to the motor to control the speed of the motor in accordance with the duty cycle of the pulse width modulated signal.
